(19) United States
(12) Patent Application Publication
(10) Pub. No.: US 2018/0181946 A1
(43) Pub. Date: Jun. 28, 2018

(54) SYSTEM AND METHOD FOR CARRYING OUT A TRANSACTION USING AUGMENTED REALITY

(71) Applicant: Mastercard Asia/Pacific Pte Ltd, Singapore (SG)

(72) Inventors: Sunitha Miryala, Singapore (SG); Rajat Maheshwari, Singapore (SG)

(73) Assignee: Mastercard Asia/Pacific Pte Ltd, Singapore (SG)

(21) Appl. No.: 15/844,285

(22) Filed: Dec. 15, 2017

(30) Foreign Application Priority Data
Dec. 23, 2016 (SG) 10201610816Y

(51) Int. Cl. G06Q 20/32; G06T 19/00; G06Q 30/02; G06Q 20/36

(52) U.S. Cl. CPC G06Q 20/3224; G06Q 20/36; G06Q 30/0222; G06T 19/006

(57) ABSTRACT

There is provided a system and method for carrying out a transaction using augmented reality. The system and method allows users to obtain information for special offers for goods/services at a merchant establishment and subsequently pay for desired goods/services with the desired special offer.

### CROSS-REFERENCE TO RELATED APPLICATIONS

This application claims the priority benefit of Singapore Application Serial No. 10201610816Y, filed Dec. 23, 2016, which is incorporated herein by reference in its entirety.

### FIELD OF THE INVENTION

The present invention relates to a system and method for carrying out a transaction using augmented reality.

### BACKGROUND OF INVENTION

The prevalence of mobile smartphones has led to a situation where users of the smartphones have ready access to a display which can be configured to provide a plethora of information. Currently, many smartphone users utilise navigation software on their smartphones to physically navigate or virtually explore a particular location. However, the navigation software typically only provides information pertaining to building or merchant names, and primarily aids the users in finding their way to a desired destination(s).

Thus, a user who utilises navigation software on the smartphone will be able to navigate to the desired destination(s), but will not be able to obtain other benefits during use of the navigation software.

Generally, the navigation software does not provide users with a facility to navigate-and-pay. The user will have to arrive at a desired destination and will have to activate a payment facility on the smartphone if necessary. Furthermore, the user will not have any guidance with regard to special promotions at the desired destination(s) and either has to expend substantial time in relation to finding out about the special promotions or may have to forego the special promotions.

Thus, the user is placed at a disadvantageous position due to a lack of information being made available to the user.

### SUMMARY OF INVENTION

In a first aspect, there is provided a system for carrying out a transaction using augmented reality. The system comprises one or more electronic processing devices that are configured to: access, at a user device, at least one digital wallet; capture, at the user device, at least one image of a merchant establishment; determine, at the user device, location parameters of the merchant establishment; transmit, from the user device, a first data package of the location parameters of the merchant establishment; determine, at a central repository server, an ID of the merchant establishment; receive, at the user device, a second data package including information on special offers for at least one good/service at the merchant establishment, the information being associated with the ID of the merchant establishment; render, at the user device, a graphical representation of the information; include, at the user device, the graphical representation on the at least one image; and initiate, at the user device, payment for the at least one good/service at the merchant establishment, the payment incorporating a desired special offer obtained from the information.

There is also provided a method for carrying out a transaction using augmented reality. The method comprises, in one or more electronic processing devices: accessing, at a user device, at least one digital wallet; capturing, at the user device, at least one image of a merchant establishment; determining, at the user device, location parameters of the merchant establishment; transmitting, from the user device, a first data package of the location parameters of the merchant establishment; determining, at a central repository server, an ID of the merchant establishment; receiving, at the user device, a second data package including information on special offers for at least one good/service at the merchant establishment, the information being associated with the ID of the merchant establishment; rendering, at the user device, a graphical representation of the information; including, at the user device, the graphical representation on the at least one image; and initiating, at the user device, payment for the at least one good/service at the merchant establishment, the payment incorporating a desired special offer obtained from the information.

There is also provided a user device for carrying out a transaction using augmented reality, the user device comprising one or more electronic processing devices that are configured to: access, at least one digital wallet; capture, at least one image of a merchant establishment; determine, location parameters of the merchant establishment; transmit, to a central repository server, a first data package of the location parameters of the merchant establishment; receive, from the central repository server, a second data package including information on special offers for at least one good/service at the merchant establishment, the information being associated with the ID of the merchant establishment; render, a graphical representation of the information; include, the graphical representation on the at least one image; and initiate, payment for the at least one good/service at the merchant establishment, the payment incorporating a desired special offer obtained from the information.

In another aspect, there is provided a non-transitory computer readable storage medium embodying thereon a program of computer readable instructions which, when executed by one or more processors of a user device in communication with a central repository server, cause the user device to perform a method for carrying out a transaction using augmented reality. The method is embodied in the steps of: accessing, at least one digital wallet; capturing, at least one image of a merchant establishment; determining, location parameters of the merchant establishment; transmitting, to the central repository server, a first data package of the location parameters of the merchant establishment; receiving, from the central repository server, a second data package including information on special offers for at least one good/service at the merchant establishment, the information being associated with the ID of the merchant establishment; rendering, a graphical representation of the information; including, the graphical representation on the at least one image; and initiating, payment for the at least one good/service at the merchant establishment, the payment incorporating a desired special offer obtained from the information.

There is also provided a central repository server for carrying out a transaction using augmented reality, the server comprising one or more electronic processing devices that are configured to: receive, from a user device, a first data package of location parameters of a merchant establishment; determine, an ID of the merchant establishment; transmit, to the user device, a second data package including information on special offers for at least one good/service at the merchant establishment, the information being associated with the ID of the merchant establishment.

In a final aspect, there is provided a non-transitory computer readable storage medium embodying thereon a program of computer readable instructions which, when executed by one or more processors of a central repository server in communication with a user device, cause the server to perform a method for carrying out a transaction using augmented reality. The method is embodied in the steps of: receiving, from a user device, a first data package of location parameters of a merchant establishment; determining, an ID of the merchant establishment; and transmitting, to the user device, a second data package including information on special offers for at least one good/service at the merchant establishment, the information being associated with the ID of the merchant establishment.

### BRIEF DESCRIPTION OF THE DRAWINGS

Preferred embodiments of the invention are hereafter described, by way of non-limiting example only, with reference to the accompanying drawings, in which:

FIG. 1 is a flow chart of an example of a method for carrying out a transaction using augmented reality;

FIG. 2 is a schematic representation of an example of a system for carrying out a transaction using augmented reality;

FIG. 3 is a schematic diagram showing components of a user device of the system shown in FIG. 2;

FIG. 4 is a schematic diagram showing components of an central repository server of the system shown in FIG. 2;

FIG. 5 is a schematic diagram showing components of an example payment processing device of the system shown in FIG. 2; and

FIGS. 6A, 6B and 6C are flow charts of a specific example of a method for carrying out a transaction using augmented reality.

### DETAILED DESCRIPTION OF PREFERRED EMBODIMENTS OF THE INVENTION

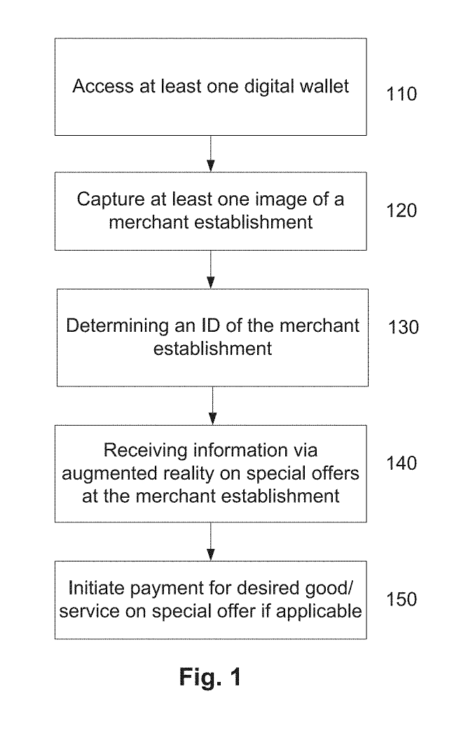

An example of a method for carrying out a transaction using augmented reality will now be described with reference to FIG. 1.

At step 110, a user initiates a request to a user device to access a digital wallet application installed on the user device in order to retrieve user account information, the user device being responsive to the request to selectively provide user account information to one or more electronic processing devices. The electronic processing devices may then receive user account information from the user device. Typically, the digital wallet application is configured to verify the user, possibly using biometric information (for example, finger prints, a voice print, an image of the user and so forth) and/or by inputting a PIN associated with the digital wallet application, to selectively provide the user account information. In this regard, the digital wallet application may prompt the user to provide verification information, selectively authenticate the user using the verification information and provide access to the user account information in response to successful verification. The user provides the PIN to the digital wallet application which verifies the PIN typically at a remote server where the user security details are stored. If the PIN is verified as correct, the user is authenticated as being the owner of the digital wallet application and in response the digital wallet application enables a payment authorization process to be carried out.

At step 120, when the user is in a vicinity of a merchant establishment, or when the user comes across a picture depicting the merchant establishment, the user captures an image of the merchant establishment. This can be carried out by, for example, using an image capture apparatus of the user device, saving the picture depicting the merchant establishment, carrying out a screen-capture from the picture depicting the merchant establishment, and so forth. It should be appreciated that the captured image should include (embed) location parameters of the merchant establishment. For example, if the user is close to the merchant establishment when capturing the image, the location parameters of the user device can be identical/similar to the location parameters of the merchant establishment. The location parameters can also be an address of the merchant establishment, or location coordinates.

Subsequently, at step 130, an ID of the merchant establishment is determined at a central repository from the image and location parameters of the merchant establishment, and correspondingly, information on special offers for at least one good/service at the merchant establishment, is provided to the user device. The information is associated with the ID of the merchant establishment, particularly if the merchant establishment has an entry at the central repository.

At step 140, the user device receives the information, for instance, using a graphical representation of the information and including the graphical representation on the image of the merchant establishment, whereby including the graphical representation on the image is carried out nearly simultaneously to the capturing of the image of the merchant establishment. To the user, it would be akin to capturing the image and subsequently being provided with the information nearly instantaneously. Including the graphical representation on the image can comprise, for example, overlaying the graphical representation on the image, providing a pop-up window for the graphical representation, providing the user with a hyperlink to access the information, and so forth.

At step 150, the user can then initiate payment for a desired good(s)/service(s), regardless of whether or not the user is at the premises of the merchant establishment. The payment can be carried out using the digital wallet application installed on the user device as mentioned in an earlier paragraph.

Accordingly, the above described method provides a number of advantages.

The present invention incorporates use of augmented reality to aid users in obtaining further information on special offers for at least one good/service at a merchant establishment, and to subsequently carry out a transaction with the merchant at the merchant establishment. It should be appreciated that the users need not be at the merchant establishment and can be at a vicinity of the merchant establishment in order to carry out the transaction. For example, the user can make an advance order for a food item on special offer and collect the food item from the merchant establishment at a later juncture. In this regard, the users are not likely to miss out on special offers from a particular merchant establishment as long as the users maintain surveillance on the particular merchant establishment. In addition, as the users can determine the special offers prior to arriving at the particular merchant establishment, a decision(s) can be made with regard to a desired good(s)/service(s) and time can be saved for the users. Furthermore, if the special offers are limited duration sessions like for example, hourly events, one-day-per-month events and so forth, the users are likely to engage in impulse purchasing behaviour which increases a number of transactions being carried out.

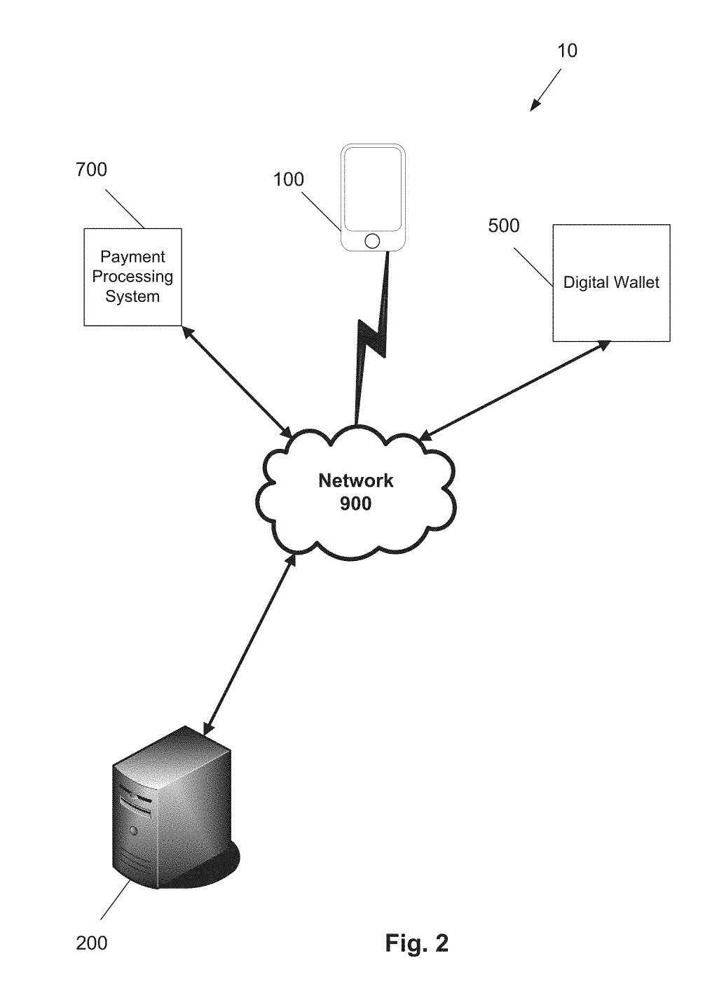

An example of a system 10 for carrying out a transaction using augmented reality will now be described with reference to FIG. 2.

In this example, the system 10 includes one or more user devices 100 running a payment application such as a digital wallet application and optionally a merchant application, a communications network 900, a central repository server 200, and a payment processing system 700.

The communications network 900 can be of any appropriate form, such as the Internet and/or a number of local area networks (LANs). It will be appreciated that the configuration shown in FIG. 2 is for the purpose of example only, and in practice the user devices 100, the central repository server 200, and payment processing device 700 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

For the purpose of illustration, it is assumed that the method for carrying out a transaction using augmented reality is performed at least in part using one or more electronic processing devices forming part of the user device 100 (such as, for example, mobile phones, portable computers, tablet computers, or the like) and forming part of the central repository server 200. The payment processing system 700 may include a number of processing devices associated with each of an issuer, acquirer, card network and payment gateway, or alternatively, the payment processing system 700 may be any one or more of these entities and this will be discussed further below. A digital wallet provider 500 can be, for example, Mastercard™ International Incorporated which provides a MasterPass™ digital wallet.

### User Device 100

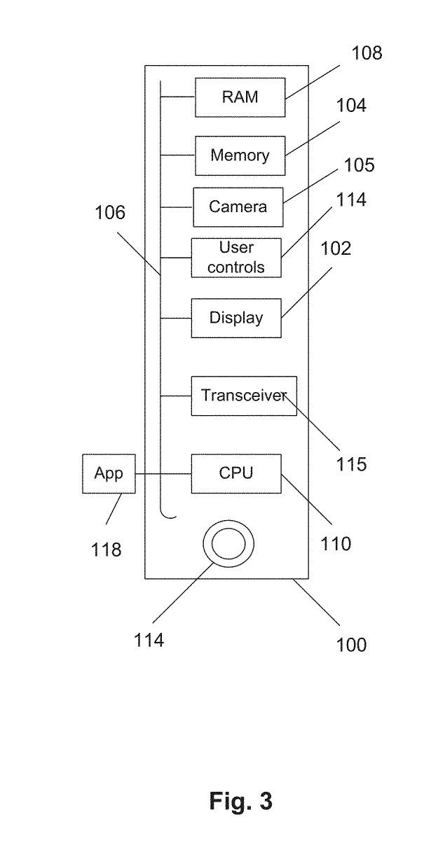

The user device 100 is a handheld computer device such as a smart phones or a PDA such as one manufactured by Apple™, LG™, HTC™, Research In Motion™, Samsung™, Huawei™, Asus™, or Motorola™. The user device 100 can also include a mobile computer such as a tablet computer, and wearable digital devices like smartwatches. An exemplary embodiment of the user device 100 is shown in FIG. 3. As shown, the device 100 includes the following components in electronic communication via a bus 106:

1. a display 102;
2. non-volatile memory 104;
3. an image capturing device 105;
4. random access memory (“RAM”) 108;
5. N processing components 110;
6. a transceiver component 115 that includes N transceivers; and
7. user controls 114.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 102 generally operates to provide a presentation of content to a user, and may be realized by any of a variety of displays (e.g., CRT, LCD, HDMI, micro-projector and OLED displays). And in general, the non-volatile memory 104 functions to store (e.g., persistently store) data and executable code including code that is associated with the functional components of a browser component and a digital wallet App 118. In some embodiments, for example, the non-volatile memory 104 includes bootloader code, modem software, operating system code, file system code, and code to facilitate the implementation of one or more portions of the digital wallet App 118 as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 115 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The image capturing device 105 typically is a camera, and there may be more than one such device on the user device 100. The image capturing device 105 can be used to capture images of the merchant establishment as described earlier.

### Central Repository Server 200

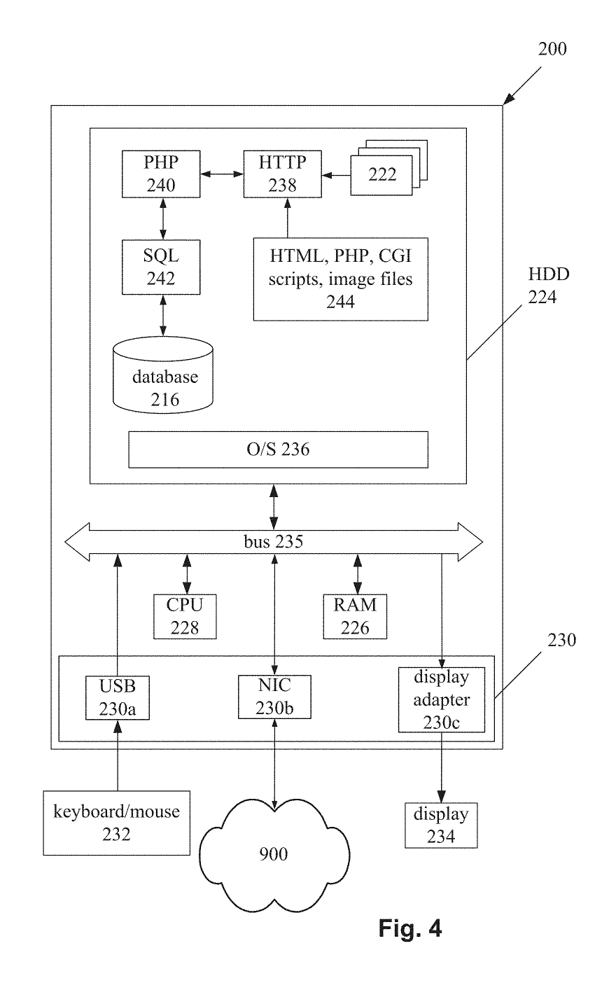

The central repository server 200 is in communication with a database 216, as shown in FIG. 4. The central repository server 200 is able to communicate within the system 10 over a communications network 900 using standard communication protocols.

The components of the central repository server 200 can be configured in a variety of ways. The components can be implemented entirely by software to be executed on standard computer server hardware, which may comprise one hardware unit or different computer hardware units distributed over various locations, some of which may require the communications network 900 for communication. A number of the components or parts thereof may also be implemented by application specific integrated circuits (ASICs) or field programmable gate arrays.

In the example shown in FIG. 4, the central repository server 200 is a commercially available server computer system based on a 32 bit or a 64 bit Intel architecture, and the processes and/or methods executed or performed by the central repository server 200 are implemented in the form of programming instructions of one or more software components or modules 222 stored on non-volatile (e.g., hard disk) computer-readable storage 224 associated with the computer system 202. At least parts of the software modules 222 could alternatively be implemented as one or more dedicated hardware components, such as application-specific integrated circuits (ASICs) and/or field programmable gate arrays (FPGAs).

The central repository server 200 includes at least one or more of the following standard, commercially available, computer components, all interconnected by a bus 235:

1. random access memory (RAM) 226;
2. at least one computer processor 228, and
3. external computer interfaces 230:
a. universal serial bus (USB) interfaces 230a (at least one of which is connected to one or more user-interface devices, such as a keyboard, a pointing device (e.g., a mouse 232 or touchpad),
b. a network interface connector (NIC) 230b which connects the computer system 202 to a data communications network, such as the Internet 900; and
c. a display adapter 230c, which is connected to a display device 234 such as a liquid-crystal display (LCD) panel device.

The central repository server 200 includes a plurality of standard software modules, including:

1. an operating system (OS) 236 (e.g., Linux or Microsoft Windows);
2. web server software 238 (e.g., Apache, available at http://www.apache.org);
3. scripting language modules 240 (e.g., personal home page or PHP, available at http://www.php.net, or Microsoft ASP); and
4. structured query language (SQL) modules 242 (e.g., MySQL, available from http://www.mysql.com), which allow data to be stored in and retrieved/accessed from an SQL database 216.

Together, the web server 238, scripting language 240, and SQL modules 242 provide the central repository server 200 with the general ability to allow users of the Internet 900 with user devices 100 equipped with standard web browser software and/or a digital wallet App to access the central repository server 200 and in particular to provide data to and receive data from the database 216. It will be understood by those skilled in the art that the specific functionality provided by the central repository server 200 to such users is provided by scripts accessible by the web server 238, including the one or more software modules 222 implementing the processes performed by the central repository server 200, and also any other scripts and supporting data 244, including markup language (e.g., HTML, XML) scripts, PHP (or ASP), and/or CGI scripts, image files, style sheets, and the like.

The boundaries between the modules and components in the software modules 222 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the central repository server 200 may be executed by a module (of software modules 222) or a portion of a module. The processes may be embodied in a non-transient machine-readable and/or computer-readable medium for configuring a computer system to execute the method. The software modules may be stored within and/or transmitted to a computer system memory to configure the central repository server 200 to perform the functions of the module.

The central repository server 200 normally processes information according to a program (a list of internally stored instructions such as a particular application program and/or an operating system) and produces resultant output information via input/output (I/O) devices 230. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Payment Processing System 700

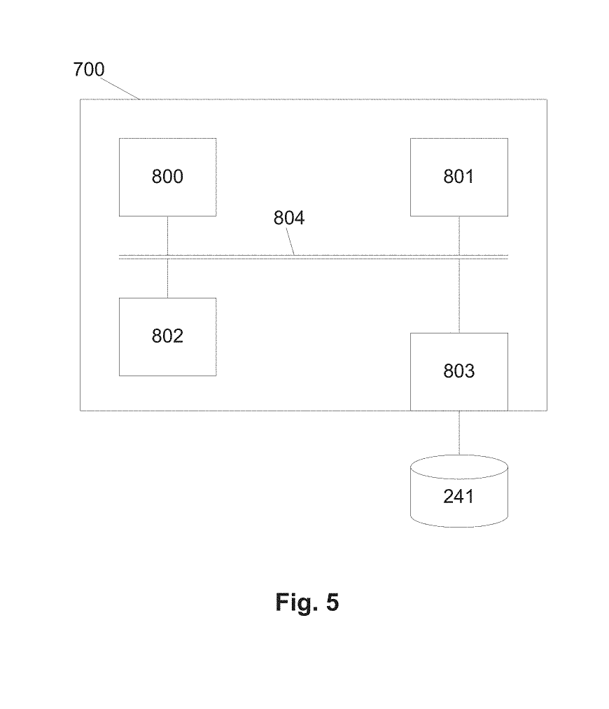

A suitable payment processing system 700 for use in the system described in any of the above examples is shown in FIG. 5.

In this example, the payment processing system 700 is a server (though in practice, the system 700 will comprise multiple such servers) that includes at least one microprocessor 800, a memory 801, an optional input/output device 802, such as a display, keyboard, touchscreen and the like, and an external interface 803, interconnected via a bus 804 as shown. In this example the external interface 803 can be utilised for connecting the payment processing system 700 to peripheral devices in the system 10, such as the central repository server 200, the communication networks 900, databases 241, other storage devices, or the like. Although a single external interface 803 is shown, this is for the purpose of example only, and in practice multiple interfaces using various methods (e.g. Ethernet, serial, USB, wireless or the like) may be provided.

In use, the microprocessor 800 executes instructions in the form of applications software stored in the memory 801 to allow communication with the payment processing system 700, for example to process payment required at the payment processing system 700. The applications software may include one or more software modules, and may be executed in a suitable execution environment, such as an operating system environment, or the like.

Accordingly, it will be appreciated that the payment processing system 700 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system is a standard processing system such as an Intel Architecture based processing system, which executes software applications stored on non-volatile (e.g., hard disk) storage, although this is not essential.

In other examples, such as described above, the payment processing system 700 is formed of multiple computer systems interacting, for example, via a distributed network arrangement. As distributed networking is known in the art, it will not be described further in more detail.

In particular, the payment processing system 700 may include or be in communication with a number of processing systems associated with each of an issuer, acquirer, card network and payment gateway, or alternatively, the payment system may be any one or more of these entities.

In one example, the payment processing system 700 sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer (in subsequent settlement and clearance processes as known in the art) who then deposits the payment into the merchant's account.

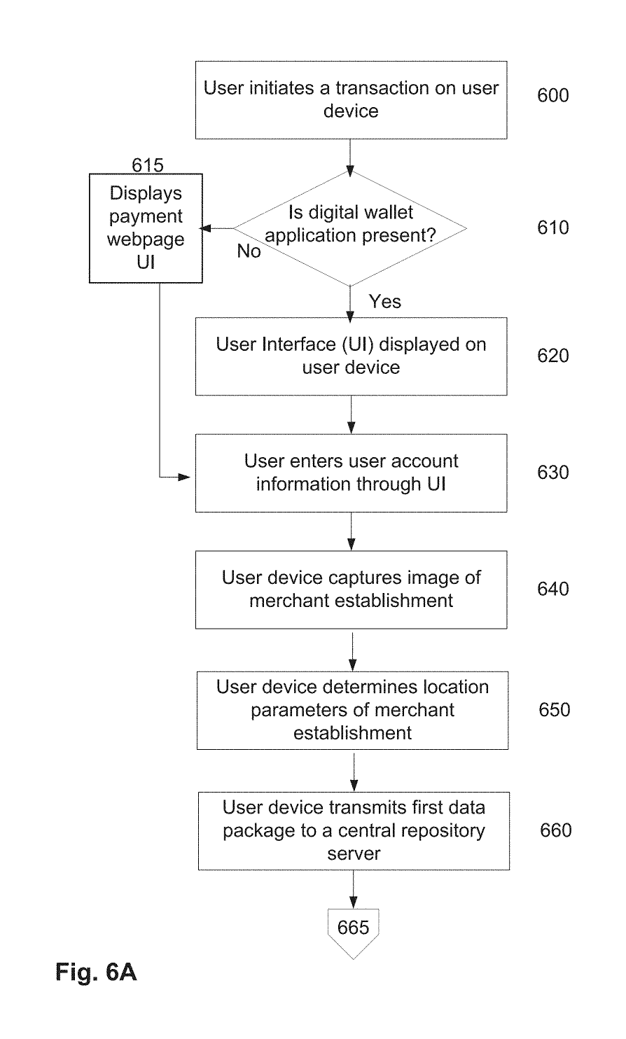

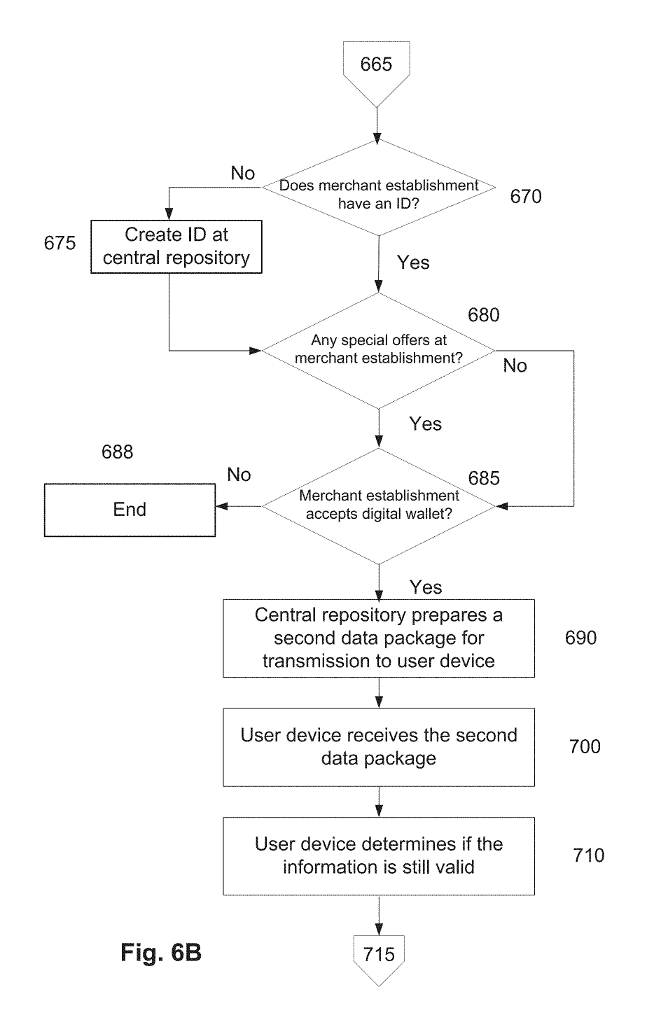

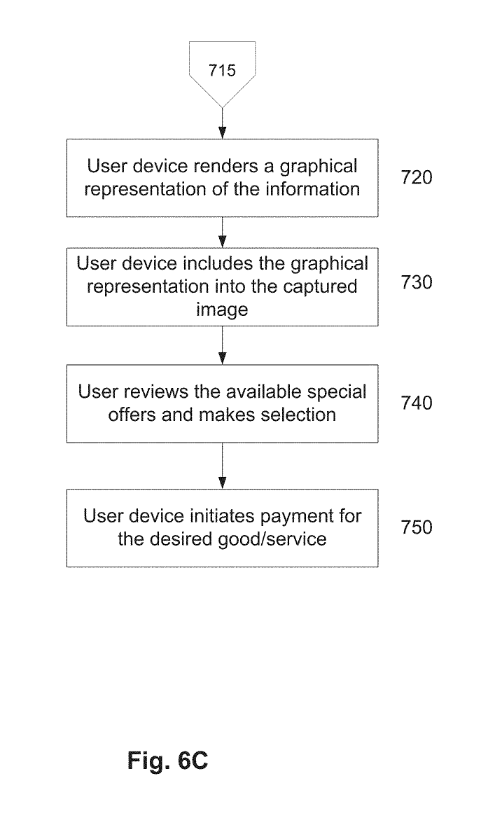

To illustrate further features of preferred practical implementations of the method, a detailed example of a method for carrying out a transaction using augmented reality will now be described with reference to FIGS. 6A, 6B and 6C.

At step 600, a user desires to perform a transaction involving the purchase of goods and/or services provided by a merchant. The user need not be at a location of the merchant's establishment.

At step 610, the user device determines whether a digital wallet application (such as MasterPass™ by Mastercard™, or a digital wallet application of a bank or other issuer) is installed on the user device. If the digital wallet application is not installed on the user device, a payment webpage UI is displayed at step 615 so as to allow the user to input account information via the UI at step 630. If the digital wallet application is installed on the user device, a payment UI is then displayed on the user device at step 620 so as to allow the user to input account information via the UI at step 630.

At step 640, the user device captures at least one image of the merchant establishment. This can be carried out by, for example, using an image capture apparatus of the user device, saving the picture depicting the merchant establishment, carrying out a screen-capture from the picture depicting the merchant establishment, and so forth. It should be appreciated that the captured image should include (embed) location parameters of the merchant establishment. For example, if the user is close to the merchant establishment when capturing the image, the location parameters of the user device can be identical/similar to the location parameters of the merchant establishment. The location parameters can also be an address of the merchant establishment, or location coordinates.

At step 650, the user device determines the location parameters of the merchant establishment, where the location parameters are, for example, location coordinates of the user device, an address of the merchant establishment, extracted from the at least one image of the merchant establishment and so forth.

Subsequently, at step 660, the user device transmits a first data package including the location parameters of the merchant establishment to a central repository server. The location parameters and name of the merchant establishment are used to determine if the merchant establishment has an associated ID at the central repository server. At step 670, the central repository server determines if the merchant establishment has an associated ID at the central repository server. If the merchant establishment has no associated ID at the central repository server, a new ID is generated and associated to the merchant establishment at step 675. If/once the merchant establishment has an associated ID, the central repository server determines if there are special offers for at least one good/service at the merchant establishment, as associated with the ID.

Subsequently, at step 685, the central repository server determines if the merchant establishment accepts payments using digital wallets. If the merchant establishment does not accept payments using digital wallets, the process ends at step 688.

If there are special offers and the merchant establishment accepts payments using digital wallets, information on the special offers is prepared in a second data package for transmission to the user device at step 690. If there are no special offers, the second data package will include information which indicates as such.

At step 700, the user device receives the second data package. At step 710, the information at the second data package is processed at the user device to determine if the special offers are valid at the particular juncture. Once the special offers in the second data package are determined to be valid, the user device then renders a graphical representation of the information at step 720.

At step 730, the user device then includes the graphical representation with the captured image of the merchant establishment. Including the graphical representation on the image is carried out nearly simultaneously to the capturing of the image of the merchant establishment. To the user, it would be akin to capturing the image and subsequently being provided with the information nearly instantaneously. Including the graphical representation on the image can comprise, for example, overlaying the graphical representation on the image, providing a pop-up window for the graphical representation, providing the user with a hyperlink to access the information, and so forth.

At step 740, the user reviews all available valid special offers for a good(s)/service(s) and makes a selection of a desired choice. Once the desired choice is made, the user can then initiate payment at the user device for a desired good(s)/service(s), regardless of whether or not the user is at the premises of the merchant establishment. The payment can be carried out using the digital wallet application installed on the user device.

The present invention incorporates use of augmented reality to aid users in obtaining further information on special offers for at least one good/service at a merchant establishment, and to subsequently carry out a transaction with the merchant at the merchant establishment. It should be appreciated that the users need not be at the merchant establishment and can be at a vicinity of the merchant establishment in order to carry out the transaction. For example, the user can make an advance order for a food item on special offer and collect the food item from the merchant establishment at a later juncture. In this regard, the users are not likely to miss out on special offers from a particular merchant establishment as long as the users maintain surveillance on the particular merchant establishment. In addition, as the users can determine the special offers prior to arriving at the particular merchant establishment, a decision(s) can be made with regard to a desired good(s)/service(s) and time can be saved for the users. Furthermore, if the special offers are limited duration sessions like for example, hourly events, one-day-per-month events and so forth, the users are likely to engage in impulse purchasing behaviour which increases a number of transactions being carried out.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A system for carrying out a transaction using augmented reality, the system comprising one or more electronic processing devices that are configured to:
access, at a user device, at least one digital wallet;
capture, at the user device, at least one image of a merchant establishment;
determine, at the user device, location parameters of the merchant establishment;
transmit, from the user device, a first data package of the location parameters of the merchant establishment;
determine, at a central repository server, an ID of the merchant establishment;
receive, at the user device, a second data package including information on special offers for at least one good/service at the merchant establishment, the information being associated with the ID of the merchant establishment;
render, at the user device, a graphical representation of the information;
include, at the user device, the graphical representation on the at least one image; and
initiate, at the user device, payment for the at least one good/service at the merchant establishment, the payment incorporating a desired special offer obtained from the information.

2. The system of claim 1, further including one or more electronic processing devices that are configured to:
determine, at the central repository server, if the merchant establishment is allocated an ID at the central repository;
determine, at the user device, a validity period of the information;
determine, at the central repository server, if the merchant establishment supports payment using the at least one digital wallet; and
select, at the user device, the desired special offer.

3. The system of claim 1, wherein the location parameters are determined from at least one of: location coordinates of the user device, an address of the merchant establishment and the at least one image of the merchant establishment.

4. The system of claim 3, further including one or more electronic processing devices that are configured to extract, at the user device, a name of the merchant establishment from the at least one image.

5. A user device for carrying out a transaction using augmented reality, the user device comprising one or more electronic processing devices that are configured to:
access, at least one digital wallet;
capture, at least one image of a merchant establishment;
determine, location parameters of the merchant establishment;
transmit, to a central repository server, a first data package of the location parameters of the merchant establishment;
receive, from the central repository server, a second data package including information on special offers for at least one good/service at the merchant establishment, the information being associated with the ID of the merchant establishment;
render, a graphical representation of the information;
include, the graphical representation on the at least one image; and
initiate, payment for the at least one good/service at the merchant establishment, the payment incorporating a desired special offer obtained from the information.

6. The user device of claim 5, further including one or more electronic processing devices that are configured to:
determine, a validity period of the information; and
select, the desired special offer.

7. The user device of claim 5, wherein the location parameters are determined from at least one of: location coordinates of the user device, an address of the merchant establishment and the at least one image of the merchant establishment.

8. The user device of claim 7, further including one or more electronic processing devices that are configured to extract, a name of the merchant establishment from the at least one image.

9. A central repository server for carrying out a transaction using augmented reality, the server comprising one or more electronic processing devices that are configured to:
receive, from a user device, a first data package of location parameters of a merchant establishment;
determine, an ID of the merchant establishment; and
transmit, to the user device, a second data package including information on special offers for at least one good/service at the merchant establishment, the information being associated with the ID of the merchant establishment.

10. The server of claim 9, further including one or more electronic processing devices that are configured to:
determine, if the merchant establishment is allocated an ID;
determine, if the merchant establishment supports payment using at least one digital wallet.

11. The server of claim 9, wherein the location parameters are determined from at least one of: location coordinates of the user device capturing an image of the merchant establishment, an address of the merchant establishment and the at least one image of the merchant establishment.
